(19) United States
(12) Patent Application Publication
(10) Pub. No.: US 2005/0131923 A1
(43) Pub. Date: Jun. 16, 2005

(54) Information processing apparatus and its control method

(75) Inventors: Toshiyuki Noguchi, Tokyo (JP); Yutaka Myoki, Yokohama-shi (JP); Masanori Saito, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/992,753

(22) Filed: Nov. 22, 2004

(30) Foreign Application Priority Data
Nov. 25, 2003 (JP) 2003-394264
Oct. 28, 2004 (JP) 2004-314724

(51) Int. Cl. G06F 7/00

(52) U.S. Cl. 707/100

(57) ABSTRACT

An information processing apparatus as a client, connected via a network to a server to provide a predetermined amount of data storage area, configured to perform file transfer to the data storage area. In the client, information on an available capacity of the data storage area is obtained. Upon receipt of the information, a GUI is displayed for a user to select file(s) to be transferred to the data storage area, and file(s) to be transferred to the data storage area is selected based on drag-and-drop designation with an input device to the displayed GUI. Then a difference value between the total size of currently selected files and the obtained available capacity of the data storage area is calculated. The result of calculation is displayed on the GUI.

### FIELD OF THE INVENTION

The present invention relates to a file transfer technique in a computer network environment, and more particularly, to a technique for, upon file transfer to a server apparatus which provides information storage area by allocating a predetermined storage capacity for a user, providing the user with information on transfer.

### BACKGROUND OF THE INVENTION

Conventionally, a service site (storage site) to provide an information storage area to a user on the network is known. For example, a photo sharing site which holds a user's images in a storage device managed by a server on the network and provides services of editing, printing, browsing and the like, is known as one of such service sites.

When a user uses such photo sharing site, the user first transfers images held on the user's computer device (user PC), digital image sensing device (digital video camera, digital still camera or the like) or an electronic device including a digital image sensing device, to a server apparatus realizing the photo sharing site (so-called upload). Thereafter, services of browsing, image processing of these uploaded images can be utilized.

In many cases, the user's upload operation is two-step operation of first selecting image(s) to be uploaded from images owned by the user on a user device and designating upload.

Upon upload, the images are uploaded to a storage area of the server, previously allocated for the user, directly from the user device or via an Internet-connectable computer device or the like, by utilizing a protocol such as HTTP (Hypertext Transfer Protocol; RFC1945 and RFC2068) or FTP (File Transfer Protocol; RFC959).

In a general photo sharing site, an upper limit is set in the storage area capacity provided to one user. In such case, the remaining capacity of the storage area on the server is checked by the user's manual inquiry operation. On the other hand, when the user has selected all the image to be uploaded on the user device and instructed to perform upload processing, the total size of the user's images is calculated on the server. Then if the value is greater than the upper limit, the user terminal is notified of the excess capacity, and the image upload processing for all the images is invalidated.

Otherwise, when the user has selected all the images to be uploaded, the total size of the selected images is calculated on the user terminal. The user terminal displays predetermined number and capacity on a display, and displays the total size of the selected images, thereby indicating whether or not the selected images can be uploaded.

However, in these conventional methods, when images are selected, the remaining capacity of the storage area on the server if these images are uploaded cannot be dynamically obtained. Thus the operability is bad.

### SUMMARY OF THE INVENTION

The present invention has been made in consideration of the above technical background, and has its object to inform a user, who is selecting images to be transferred, of the remaining capacity of storage area as a transfer destination if selected images are transferred.

The above objects are solved by the present invention. According to one aspect of the present invention, firstly, information on an available capacity of a data storage area on a server is obtained. Upon receipt of the information, a GUI is displayed for a user to select file(s) to be transferred to the data storage area, and file(s) to be transferred to the data storage area is selected based on drag-and-drop designation with an input device to the displayed GUI. Then a difference value between the total size of currently selected files and the obtained available capacity of the data storage area is calculated. The result of calculation is displayed on the GUI.

Other and further objects, features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with-the description, serve to explain the principles of the invention.

FIG. 1 is an explanatory view showing the entire configuration of a network system according to an embodiment of the present invention;

FIG. 2 is a block diagram showing the configuration of a computer apparatus used as a client and a server according to the embodiment;

FIG. 3 is a block diagram showing the software configuration of the network system according to the embodiment;

FIG. 4 illustrates an example of the structure of user information database and a record;

FIG. 5 illustrates an example of the structure of album information database and a record;

FIG. 6 is a sequence diagram showing the entire operation of the network system according to the embodiment;

FIG. 7 is an example of an authentication information input screen image;

FIG. 8 shows the authentication information input screen image in FIG. 7 where authentication information has been inputted;

FIG. 9 is a flowchart showing the operation of album query CGI;

FIG. 10 is an example of an authentication error screen image;

FIG. 11 is an example of an upload screen image (initial display);

FIG. 12 illustrates an example of the data structure of an upload program;

FIG. 13 is a flowchart showing an upload screen image display operation;

FIG. 14 is an example of a cell list when image files are added;

FIG. 15 is an example of the upload screen image corresponding to the cell list in FIG. 14;

FIG. 16 is an example of the cell list when a selection status is changed;

FIG. 17 is an example of the upload screen image corresponding to the cell list in FIG. 16;

FIG. 18 is a flowchart showing the operation of an upload CGI;

FIG. 19 is an example of the album information database after upload;

FIG. 20 is a flowchart showing an operation of an album display CGI; and

FIG. 21 is an example of an album display screen image.

### DETAILED DESCRIPTION OF THE PREFERRED EMBODIMENT(S)

A preferred embodiment of the present invention will now be described in detail in accordance with the accompanying drawings.

In the present embodiment, a network system to transfer (so-called “upload”) image file(s) by a user's operation, from a user PC (client) as an information processing apparatus to a server which provides a photo sharing service will be described. The server provides each user with a storage area called an “album”. The capacity of the storage area available as an album is previously determined for each user. When the user uploads image file(s) from the client, the server stores the uploaded image file(s) in the album.

Note that the present invention is not limited to such server to provide a photo sharing service, but the present invention is applicable to any server as long as it provides a predetermined storage capacity to a user. Further, the computer network to which the server device is connected is not limited to the Internet, but it is preferable that the computer network uses a so-called Internet protocols such as TCP/IP.

<On Unit System>

In the present specification, (byte) is used as a unit of file size. Further, KB (kilobyte) is used as abbreviation of unit of 2¹⁰ (1,024) bytes. Further, MB (megabyte) is used as abbreviation of unit of 2²⁰ (1,048,576) bytes.

In the International System of Units (SI), a small letter k (kilo) as a prefix represents 103 and a capital letter M (mega) also as a prefix represents 106. Further, according to the determination of the International Electrotechnical Commission (IEC), to avoid confusion with the prefixes of International System of Units, Ki (kibi) is used as a prefix to represent 2¹⁰, and Mi (mebi) is used as a prefix to represent 2²⁰.

In accordance with the above standards, 2¹⁰ bytes should be denoted as KiB (kibibyte), and 2²⁰ bytes, Mib (mebibyte), however, in the present specification, 2¹⁰ bytes is denoted as KB and 2²⁰ bytes, as MB, in conformity with usage of the computer industry.

<Entire Configuration>

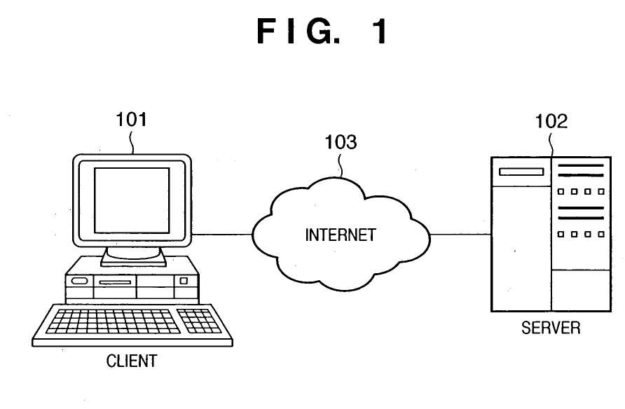

FIG. 1 is an explanatory view showing the entire configuration of a network system according to the present embodiment.

Reference numeral 101 denotes an information processing apparatus such as a personal computer used by a user (hereinbelow, referred to as a “user PC”) which functions as a client computer to perform an image file upload operation. The client 101 is connected to the Internet 103 via a network interface. Numeral 102 denotes a server which provides a storage area and receives image file upload. The server 102 is also connected to the Internet 103 via a network interface. The client 101 and the server 102 perform mutual communication by using, e.g., the HTTP protocol, through the Internet 103. Note that plural clients 101 may exist, however, for the sake of simplicity of explanation, one client 101 is shown here.

<Client 101 and Server 102>

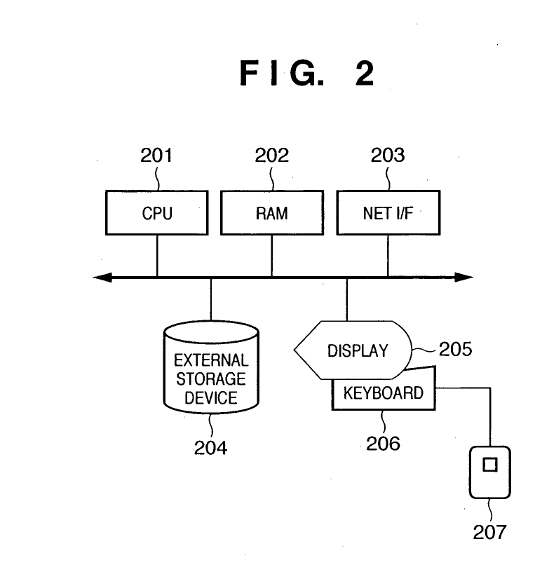

FIG. 2 is a block diagram showing the configuration of a computer apparatus used as the client 101 and the server 102. Numeral 201 denotes a CPU which controls the entire computer apparatus; 202, a RAM which functions as a main storage unit; 203, a network interface (Net I/F) which establishes connection with a network such as the Internet to transmit/receive data and the like under the control of the CPU 201; 204, an external storage unit such as a magnetic disk for data storage; 205, a display as a display device which displays an image; and 206 and 207, a keyboard and a pointing device (mouse or the like) as input devices to input the user's instructions. Programs stored in the RAM 202 use the functions of an OS (Operating System) also stored in the RAM 202 in accordance with necessity, to perform data reading/writing to/from the RAM 202, data reading/writing to/from the external storage unit 204, data transmission/reception through the network interface 203, reception of input from the keyboard 206 or the pointing device 207, and display on the display 205, thereby perform predetermined operations.

<Entire Block Diagram>

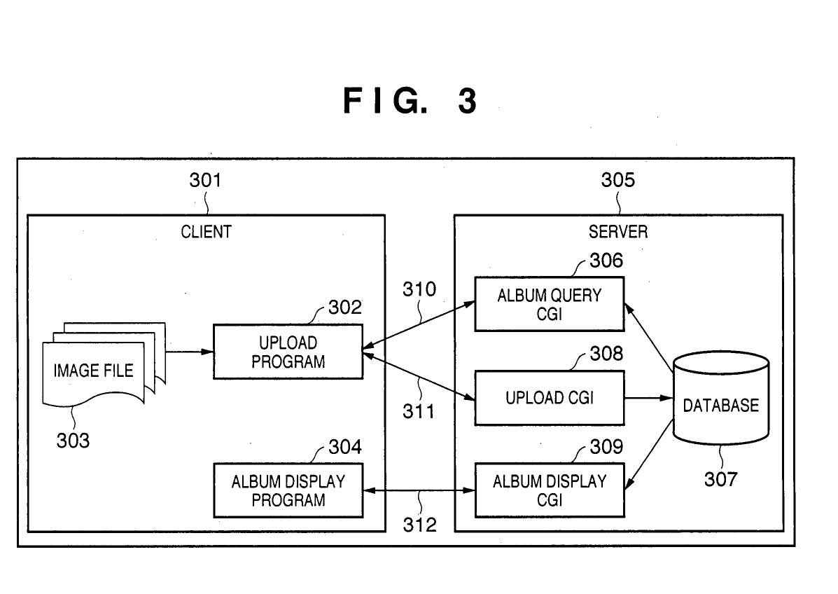

Next, the software configuration of the network system according to the present embodiment will be described with reference to FIG. 3.

FIG. 3 shows the configurations of logical blocks mainly relate to the operation of the present embodiment, i.e., a program module, a file entity, a database entity and communication paths in the client 101, the server 102 and the Internet 103 having the configuration as shown in FIG. 1.

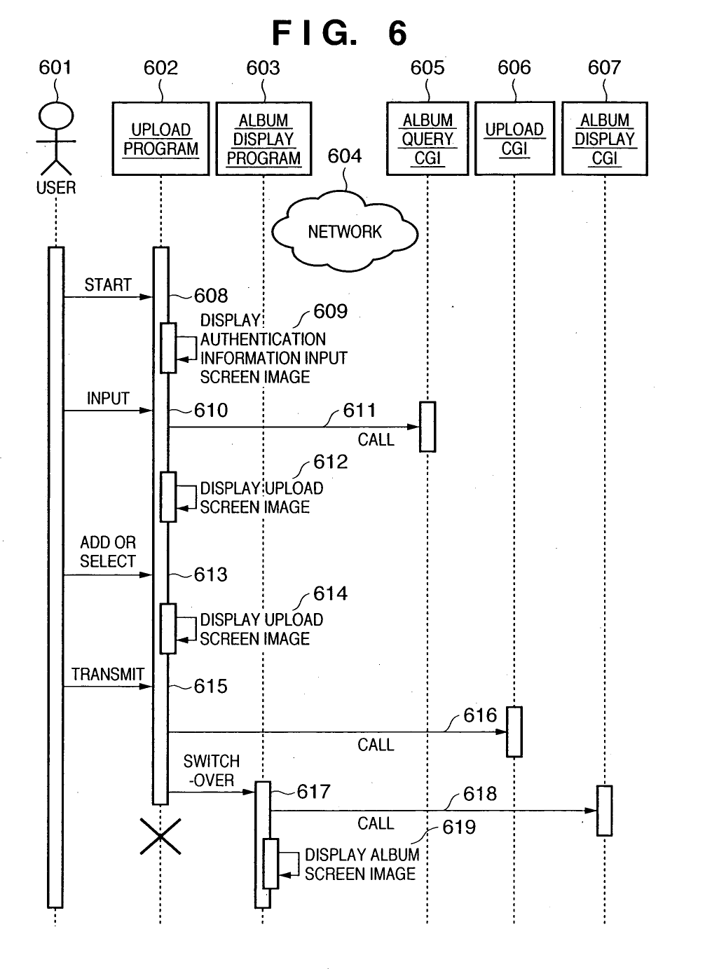

Numeral 301 denotes a block boundary of the client 101, indicating an environment under the control of the OS. Generally, an upload program 302 and an album display program 304 are stored in the external storage unit 204, and when the user, the OS, or another program has requested execution, the programs are read to the RAM 202 by the control of the OS, and become executable status. Numeral 303 denotes image files stored in the external storage unit 204. The image files 303 can be read/written from an arbitrary program, however, in this embodiment, as indicated by an arrow between the image files 303 and the upload program 302 and its direction, merely the upload program 302 reads the contents of the image files 303. The operations of the upload program 302 and the album display program 304 will be described later with reference to FIG. 6 and the subsequent figures.

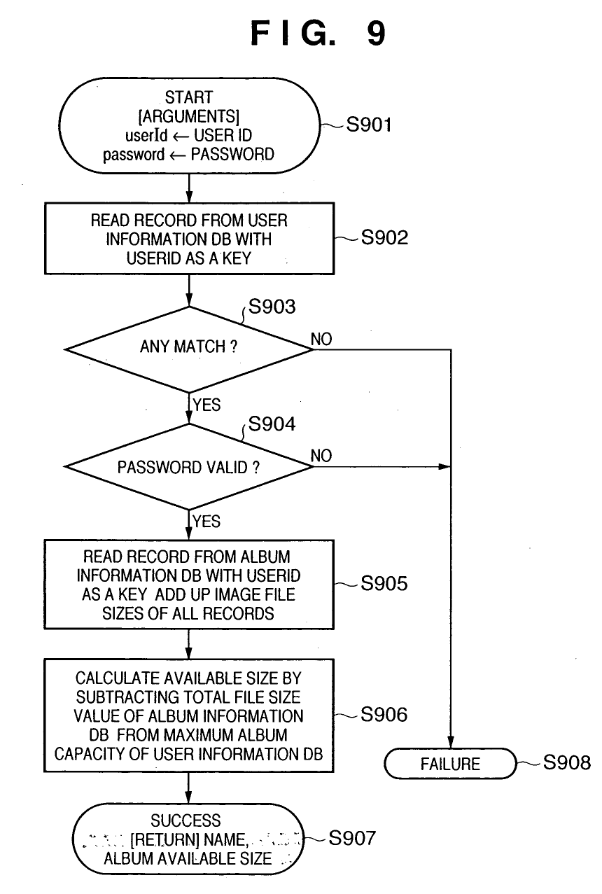

Numeral 305 denotes a block boundary of the server 102, indicating an environment under the control of the OS. An album query CGI 306, an upload CGI 308 and an album display CGI 309 are CGI (Common Gateway Interface) programs. Generally, these programs are stored in the external storage unit 204, and when the client 301 has requested execution in the form of HTTP request, the programs are read to the RAM 202 by the control of the OS and a Web server program (not shown), and become executable status. The CGI program receives argument(s) necessary for execution through request parameter(s) of an HTTP request, and transmits the result of execution through an HTTP response. Numeral 307 denotes a database constructed on the external storage unit 204 by a database program (not shown). The CGI programs 306, 308 and 309 can read/write the contents of the database 307 by utilizing the functions of the database program and a database driver (not shown) in accordance with necessity. In this embodiment, as indicated by arrows in the server block 305 and their directions, the album query CGI 306 and the album display CGI 308 read the contents of the database 307 and the upload CGI 308 writes data in the contents of the database 307. The operations of the album query CGI 306, the upload CGI 308 and the album display CGI 309 will be described later with reference to FIGS. 9, 18, 20 and the subsequent figures.

Numerals 310, 311 and 312 denote HTTP communication paths used between the client execution environment 301 and the server execution environment 305. In the respective communication paths, connection is established on the Internet 103 in the form of HTTP request for execution of CGI program on the server 305 from the program on the client 301, and when an HTTP response is returned from the CGI program on the server 305 to the program on the client 301, the connection is automatically broken as long as an instruction to maintain the connection has been issued.

<Database Structure and Record>

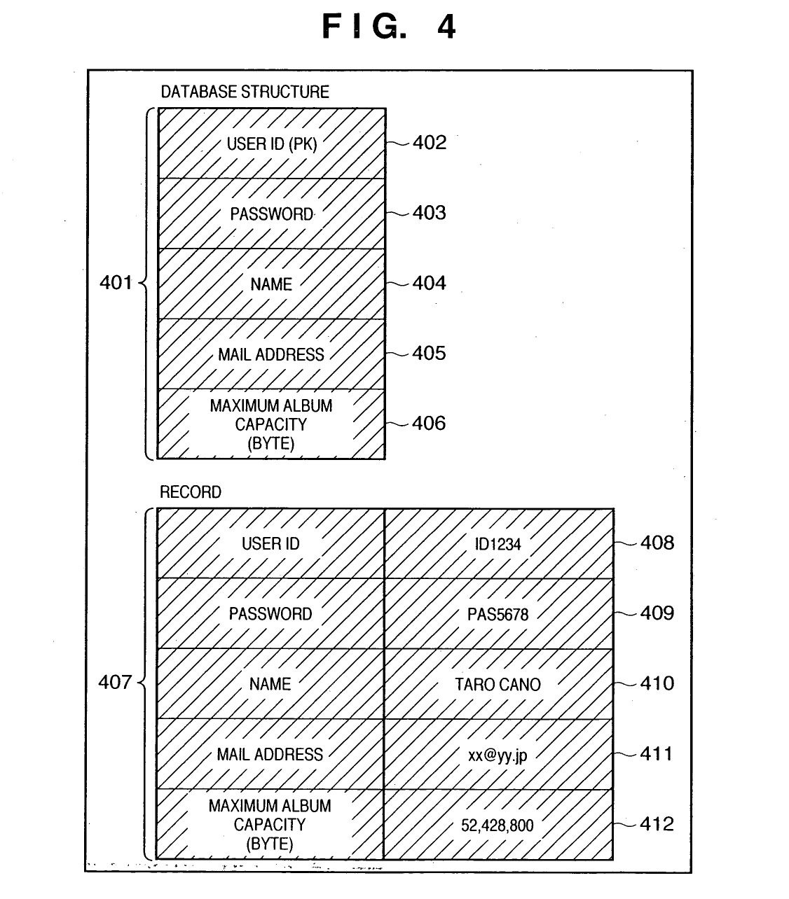

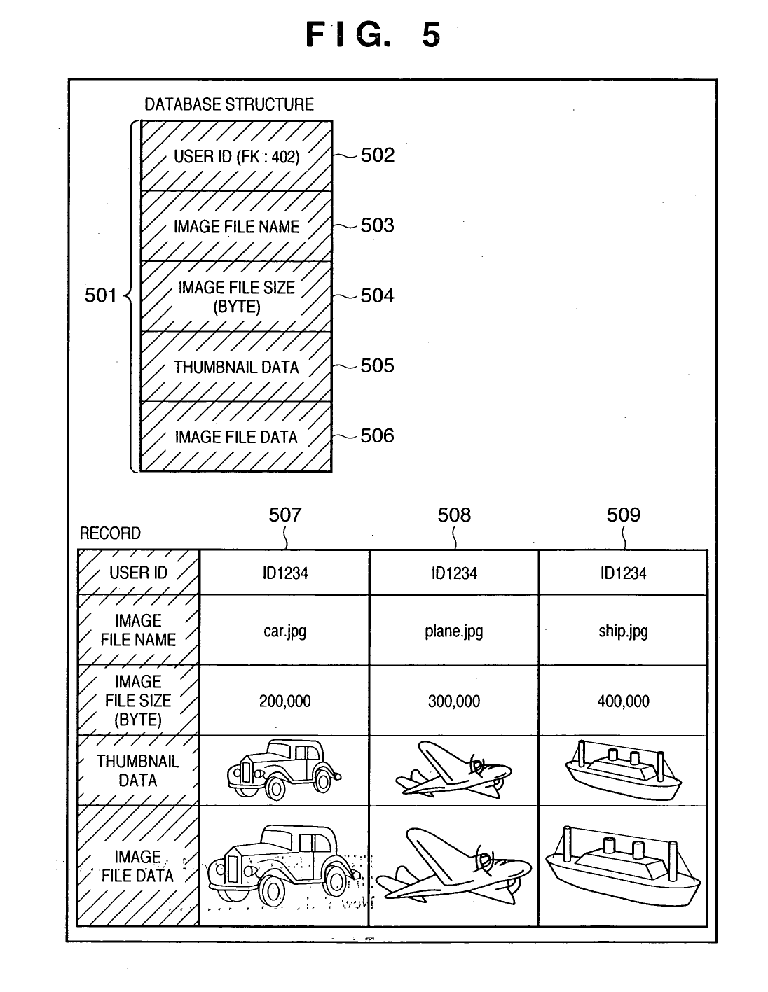

Next, the structure of the database and record used in the present embodiment will be described with reference to FIGS. 4 and 5.

FIG. 4 illustrates an example of the structures of a database constructed in the database 307 for storing user information and a record.

Numeral 401 denotes a user information database structure including data rows 402 to 406. Numeral 402 denotes a user ID issued for identification of user. As PK (Primary Key) is designated, it is ensured by the database program that the user ID 402 is not overlapped in all the rows (records) included in the user information database 401. Accordingly, all the records in the user information 401 can be uniquely discriminated with the user ID 402 as a key. Numeral 403 denotes an authentication password; 404, a user name; 405, a user mail address; and 406, a capacity allocated for the user as an available storage area, i.e., the maximum capacity of album. As described above, byte is used as the unit.

Numeral 407 denotes a record of the user information used in the present embodiment. As shown in FIG. 4, as data corresponding to the data rows 402 to 406 of the database structure, data “ID1234”, “PAS5678”, “Taro Cano”, “xx@yy.jp” and “52,428,800” are stored in rows 408 to 412. The maximum album capacity is 52,428,800 bytes, i.e., 50 MB.

FIG. 5 illustrates an example of the structure of a database constructed in the database 307 for storing album information and a record.

Numeral 501 denotes an album information database structure including data rows 502 to 506. Numeral 502 denotes a user ID. As 402 (See FIG. 4) is designated as FK (Foreign Key), when a record is added to the album information database 501, it is ensured by the database program that a record having the same ID as the user ID 502 exists in the user information database 401. Numeral 503 denotes a image file name; 504, an image file size (unit is byte); 505, image file thumbnail data; and 506, image file data. The thumbnail data 505 and the image file data 506 are stored as binary data into the database, however, since they cannot be illustrated in that form, the content of image file is illustrated in the present embodiment.

Numerals 507 to 509 denote album information records used in the present embodiment, i.e., records having the album information of the user indicated in 407 (See FIG. 4). In the record 507, “ID1234”, “car.jpg”, “200,000”, “(binary data corresponding to the illustrated thumbnail)”, and “(binary data corresponding to the illustrated image)” are stored as data corresponding to rows 502 to 506 of the database structure. The image file size is 200,000 bytes, i.e., about 195 KB. Regarding rows 508 and 509, data are stored in a similar manner.

<Entire Operation>

Next, the entire operation of the present embodiment will be described with reference to FIG. 6.

FIG. 6 is a UML (Unified Modeling Language) sequence diagram showing the entire operation of the network system according to the present embodiment. FIG. 6 mainly shows normal series operations but may omit abnormal series (upon occurrence of error or processing failure) operations.

Numeral 601 denotes a user who operates the client 101.

Numeral 602 denotes an instance of the upload program 302, i.e., an entity in a status where the upload program 302 is read to the RAM 202 of the client 101 and is executable. Numeral 603 denotes an instance of the album display program 304.

Numeral 604 denotes a network boundary between the client 301 and the server 305. Note that this is not UML description but convenience description indicating that the operations are executed in different environments on the left side (client side) and on the right side (server side) in the sequence diagram.

Numeral 605 denotes an instance of the album query CGI 306, i.e., an entity in a status where the album query CGI 306 is read to the RAM 202 of the server 102 and is executable. Numeral 606 denotes an instance of the upload CGI 308; and 607, an instance of the album display CGI 309.

First, the user 601 instructs the OS to execute the upload program 302 by using the keyboard 206 and/or the pointing device 207 of the client 101 (sequence 608). The OS reads the upload program 302 from the external storage unit 204 to the RAM 202, and generates the instance 602 of the upload program 302.

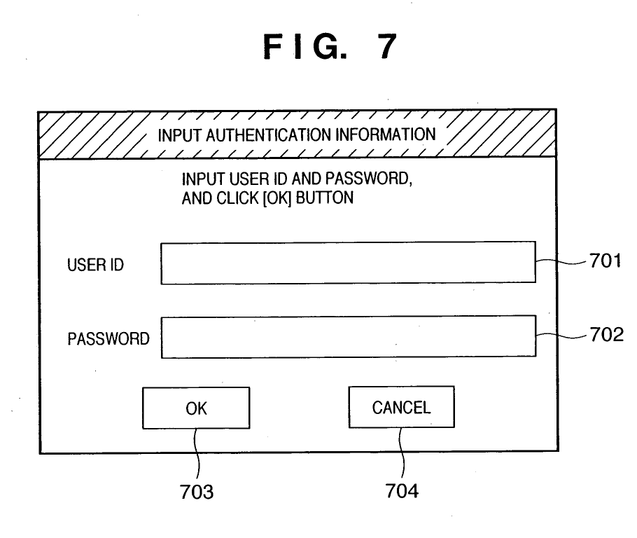

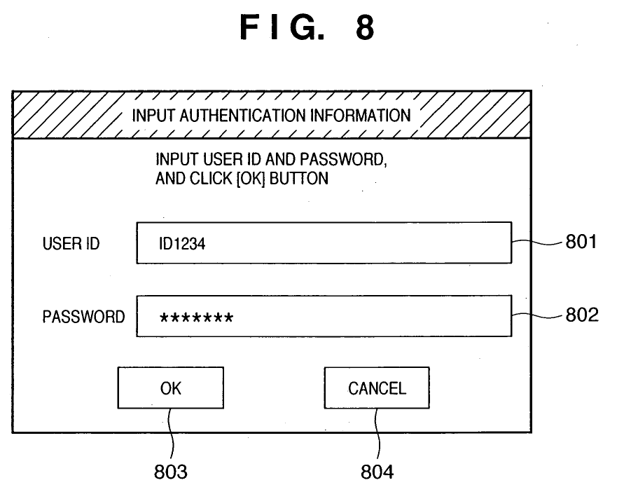

When the execution is started, the upload program 602 first displays an authentication information input screen image on the display 205 (sequence 609). The user 601 inputs authentication information to the displayed authentication information input screen image by using the keyboard 206 and/or the pointing device 207 of the client 101 (sequence 610). The details of the authentication information input screen image and the input will be described later with reference to FIGS. 7 and 8.

When the user 601 has inputted the authentication information, the upload program 602 requests the server 102 to execute the album query CGI 306 in the form of HTTP request via the network 103 (sequence 611). At this time, the authentication information inputted by the user 601 is forwarded as execution arguments. The OS and the Web server program on the server 102 establish HTTP connection 310 with the upload program 602, then read the album query CGI 306 from the external storage unit 204 to the RAM 202, and generate the instance 605 of the album query CGI. The album query CGI 605 checks the authentication information designated with the arguments, and returns user information and album information designated with the arguments in the form of HTTP response to the upload program 602. The details of the operation of the album query CGI 605 will be described later with reference to FIG. 9. As described later, in response to the request for execution of the album query CGI 306, an available album size is returned. Accordingly, the available capacity of the album set for the user can be obtained at this time.

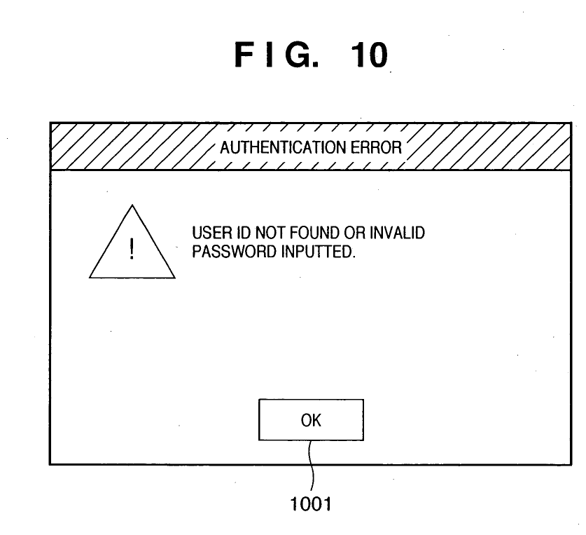

When the calling of the album query CGI 605 has been made, the upload program 602 displays an upload screen image as a GUI (Graphical User Interface) on the display 205 by utilizing the information returned in the HTTP response (sequence 612). The user 601 adds image file(s) to be added or selects whether the added image file(s) are to be uploaded or not in the displayed upload screen image, by using the keyboard 206 and/or the pointing device 207 of the client 101 (sequence 613). Every time when the user 601 has added or selected an image, the upload program 602 updates the display of the upload screen image (sequence 614). The sequences 613 and 614 can be repeatedly performed by the user 601. The details of the display of the upload screen image will be described later with reference to FIGS. 10 to 17. In the upload screen image, a total file capacity of the currently-selected image files and the available album size obtained by the sequence 611 are dynamically displayed.

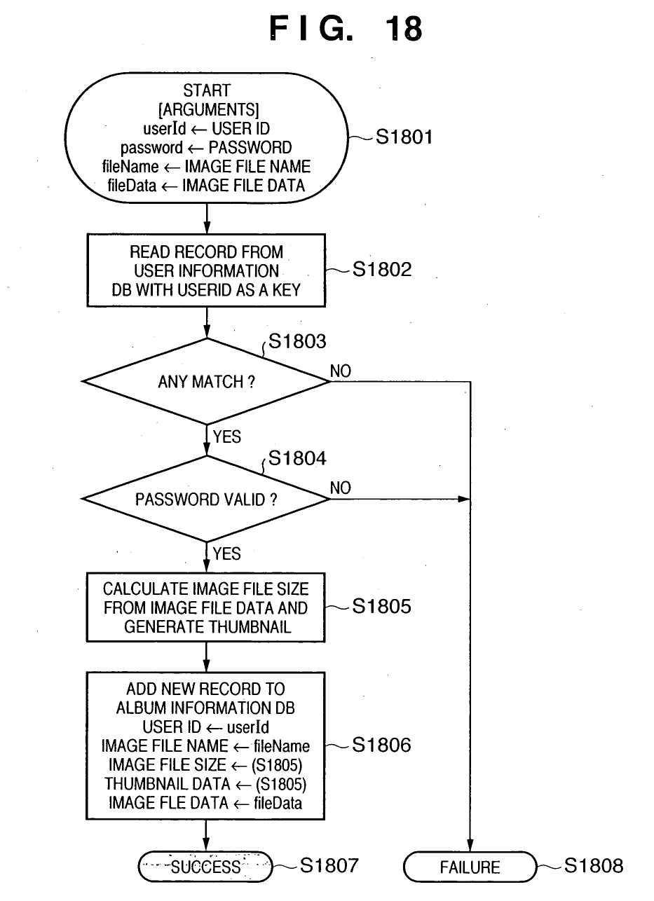

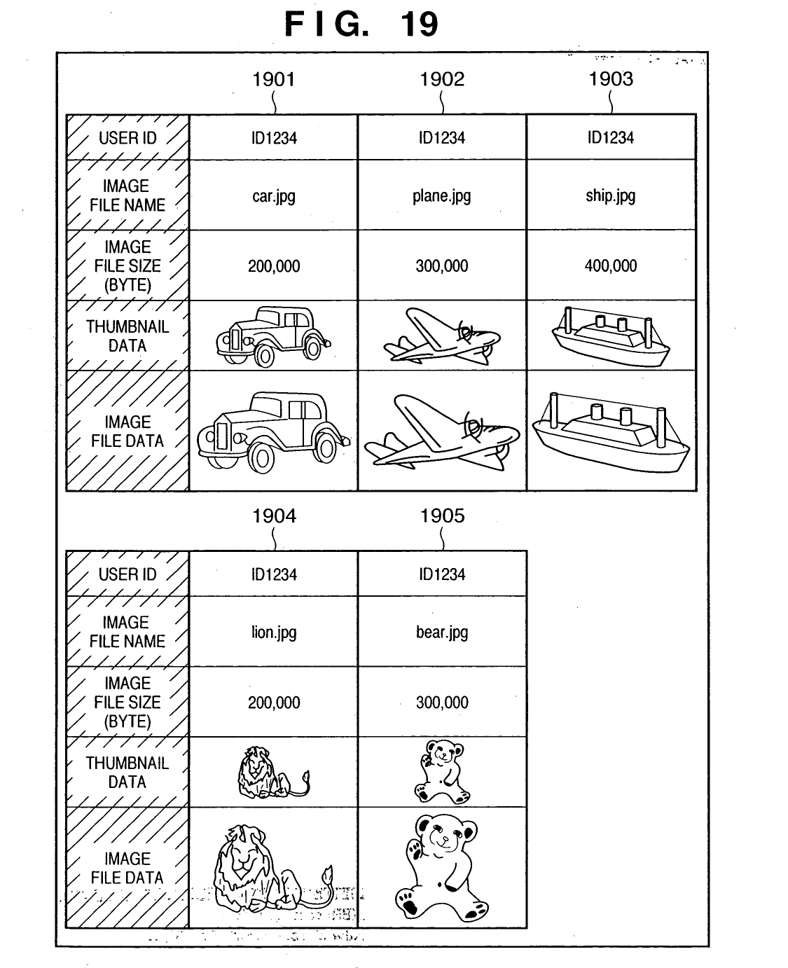

When the preparation of image file(s) to be uploaded has been made, i.e., if it is determined that the sequence 613 and 614 are not to be repeated any longer, the user 601 requests the upload program 602 to upload the image file(s) by using the keyboard 206 and/or the pointing device 207 of the client 101 (sequence 615). The upload program 602 requests the server 102 to execute the upload CGI 308 in the form of HTTP request via the network 103 (sequence 616). At this time, in addition to the user information of the user 601, information on the image file(s) selected by the user 601 is forwarded as execution arguments. The OS and the Web server program on the server 102 establish HTTP connection 311 with the upload program 602, then read the upload CGI from the external storage unit 204 to the RAM 202, and generate the instance 606 of the upload CGI. The upload CGI 606 registers the image file(s) designated with the arguments in the user's album designated with the arguments, and returns the result of processing in the form of HTTP response to the upload program 602. This operation (sequence 616) is repeated by the number of the uploaded image files. The details of the operation of the upload CGI 606 will be described with reference to FIGS. 18 and 19.

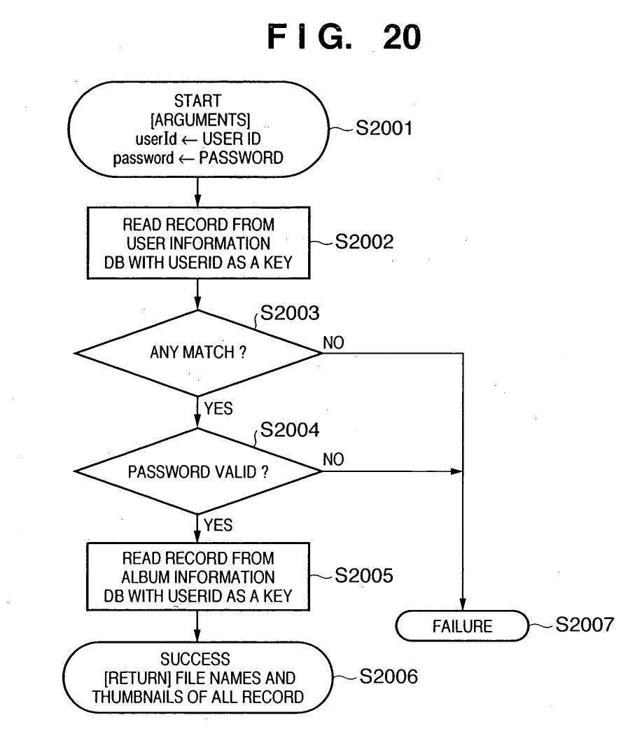

When all the calling of the upload CGI 208 has been made, the upload program 602 requests the OS to execute the album display program 304, and the execution of the program itself ends (sequence 617). At this time, the authentication information inputted at the sequence 610 is forwarded as an execution arguments. The OS reads the album display program 304 from the external storage unit 204 to the RAM 202, and generates the instance 603 of the album display program. When the execution of the program has been started, the album display program 603 requests the server 102 to execute the album display CGI 309 in the form of HTTP request via the network 103 (sequence 618). At this time, the authentication information forwarded from the upload program 602 upon starting is forwarded as an execution arguments to the album display CGI 309. The OS and the Web server program on the server 102 establish HTTP connection 312 with the album display program 603, then reads the album display CGI 309 from the external storage unit 204 to the RAM 202, and generates the instance 607 of the album display CGI. The album display CGI 607 returns the information on the image file(s) included in the user's album designated with the argument(s) in the form of HTTP response to the album display program 603. The details of the operation of the album display CGI 607 will be described later with reference to FIG. 20.

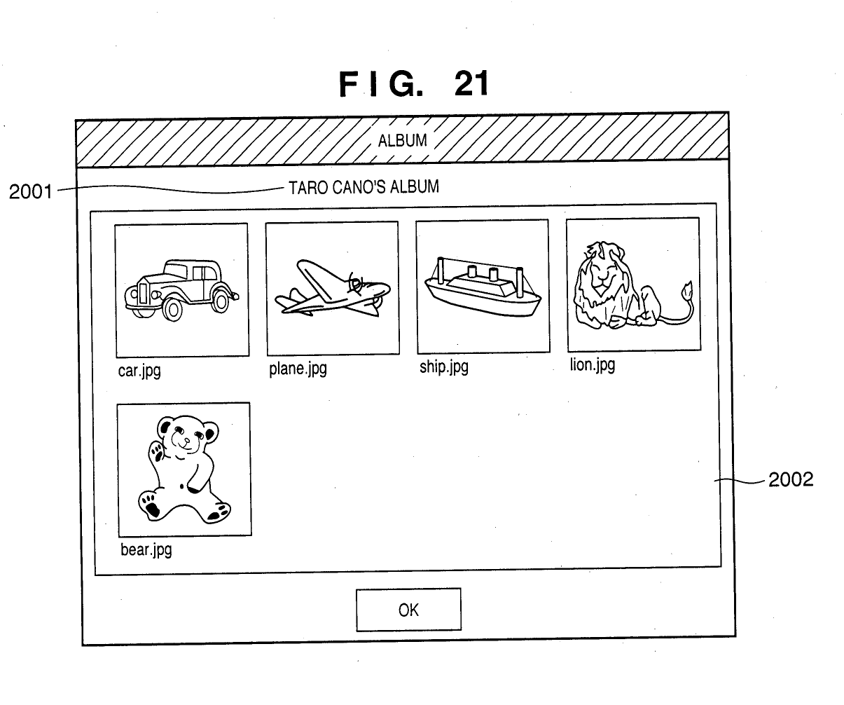

When the calling of the album display CGI 607 has been made, the album display program 603 displays an album screen image on the display 205 by utilizing the information returned in the HTTP response (sequence 619). The display of the album screen image will be described later with reference to FIG. 21.

The entire operation of the present embodiment is as described above. Next, the details of the respective operations will be described hereinbelow.

<Input Authentication Information Input Screen Image>

The display and input in the authentication information input screen image will be described with reference to FIGS. 7 and 8.

FIG. 7 is an example of the authentication information input screen image displayed by the upload program 602 at sequence 609. The user 601 performs input or operation by using the keyboard 206 and/or the pointing device 207 of the client 101. Numeral 701 denotes a user ID input field; and 702, a password input field. When the user 601 operates an OK button 703, the upload program 602 determines that the input has been completed. When the user 601 operates a cancel button 704, the upload program 602 determines that the execution of the program has been cancelled, and the program ends (The operation upon operation of the cancel button 704 is not shown in FIG. 6).

FIG. 8 is an example of the authentication information input screen image when the user 601 has inputted authentication information at sequence 610. In this example, the input authentication corresponds to the record 407 in the user information database 401. “ID1234” corresponding to the user ID 408 is inputted in the user ID input field 801. In the password input field 802, the input characters are not echoed-back but all the characters are indicated with “*” in terms of security, however, “PAS5678” corresponding to the password 409 is inputted as in the case of the user ID.

<Operation of Album Query CGI>

Next, the operation of the album query CGI will be described with reference to FIG. 9.

FIG. 9 is a flowchart showing an operation of the album query CGI 605 (sequence 611).

At step S901, the program starts. As the user ID and the password inputted by the user 601 in the authentication information input screen image shown in FIG. 7 are forwarded from the upload program 602 as HTTP request parameters, they are substituted into variables “userId” and “password”. In this example, “ID1234” as the user ID and “PAS5678” as the password are forwarded as shown in FIG. 8.

At step S902, a record with the “userId” corresponding to the user ID 402 is retrieved from the user information database 401. As shown in FIG. 4, since the user ID 402 is a PK, only 1 record matches the user ID 402.

At step S903, it is determined whether or not a record has been found at step S902. If it is determined that a record has not been found, it is determined that the user ID is invalid, then the process proceeds to step S908, at which the program is terminated, and “failure” is returned to the upload program 602. If it is determined that a record has been found, the process proceeds to step S904. In this example, as the “userId” is “ID1234”, the record 407 as shown in FIG. 4 is found, and the process proceeds to step S904.

At step S904, it is determined whether or not the password 403 of the record found at step S902 corresponds with the “password” forwarded as an argument. If the passwords do not correspond with each other, it is determined that the password is invalid, then the process proceeds to step S908, at which the program is terminated, and “failure” is returned to the upload program 602. If the passwords correspond with each other, the process proceeds to step S905. In this example, as the password of the record 407 is “PAS5678” (409) and the “password” is “PAS5678”, the process proceeds to step S905.

At step S905, all the records with the “userId” corresponding to the user ID 502 are retrieved from the album information database 501, and the image file size 504 of the found records is obtained as an accumulated total size. In this example, as userId =“ID1234” holds, the three records 507 to 509 shown in FIG. 5 are found, and as a result of accumulation of the image file size, 200,000+300,000+400,000=total 900,000 bytes is obtained.

At step S906, the total image file size obtained at step S905 is subtracted from the maximum album capacity 406 of the user information database 401, thereby an available album size is calculated. In this example, as the maximum album capacity is 52,428,800 bytes (412 in FIG. 4) and the total image file size is 900,000 bytes, 52,428,800−900,000=51,528,800 bytes is obtained.

Then at step S907, the program is terminated, and “success” is returned to the upload program 602. At this time, a returned value is returned as a part of HTTP response. In this example, “Taro Cano” as the name 410 of the found record 407 and the available album size “51,528,800” obtained at step S906 are returned.

<Upload Screen Image (Initial Image)>

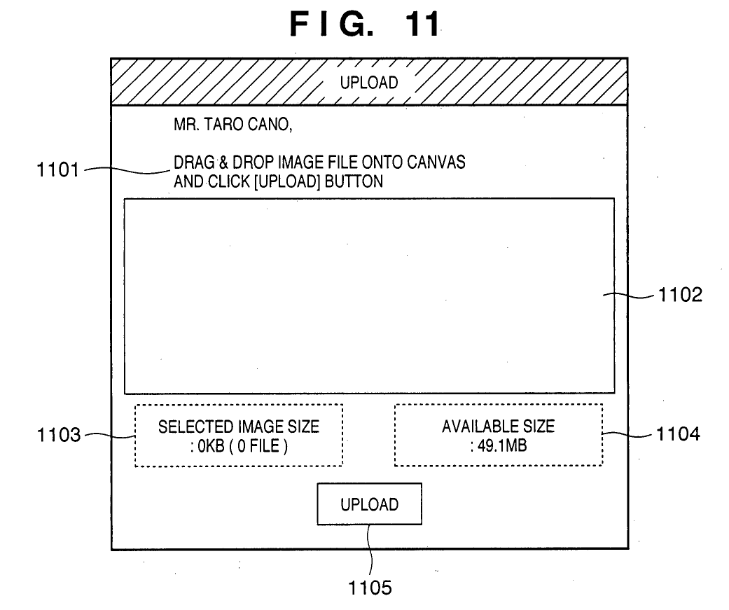

Next, an initial image of the upload screen image will be described with reference to FIGS. 10 and 11.

FIG. 10 is an example of an authentication error screen image displayed by the upload program 602 on the display 205 when the calling of the album query CGI 605 (sequence 611) has returned “failure”. As shown in FIG. 9, the upload program 602 returns “failure” if the argument userID or password is invalid. In FIG. 10, a message “User ID not found or invalid password inputted.” is displayed. For the sake of convenience of security, “User ID not found” or “invalid password inputted” is not clearly indicated. Numeral 1001 denotes an OK button. When the user 601 uses this button with the keyboard 206 or the pointing device 207, the upload program 602 deletes the authentication error screen image, and displays the authentication information input screen image at sequence 609 (the operation related to the authentication error screen image display is not shown in FIG. 6).

FIG. 11 is an example of an upload screen image displayed by the upload program 602 on the display 205 at sequence 612.

Numeral 1101 denotes a fixed message where the name “Taro Cano” returned as a returned value at sequence 611 is used as a part of the first line.

Numeral 1102 denotes a canvas in which image file(s) is added in this rectangular area. As the way of addition, the user 601 drags the image file(s) 303 existing in the external storage unit 204 and drops the image file(s) onto the canvas 1102 by using the pointing device 207.

Numeral 1103 denotes an area where the total size of and the number of image files to be uploaded are displayed. In this example, as no image file has been added, “0 KB (0 file)” is displayed.

Numeral 1104 denotes an area where the available album size returned as the returned value at sequence 611 is displayed. In this example, as “51,528,800 bytes”=“49.124 megabytes”≅“49.1 megabytes” holds, “49.1 MB” is displayed. In this manner, the available album size is already displayed at this time.

Numeral 1105 denotes an upload button. When the user operates the upload button 1105 with the keyboard 206 or the pointing device 207, the upload program 602 is instructed to upload the image file(s) added to the canvas 1102.

<Upload Program Data Structure and Operation>

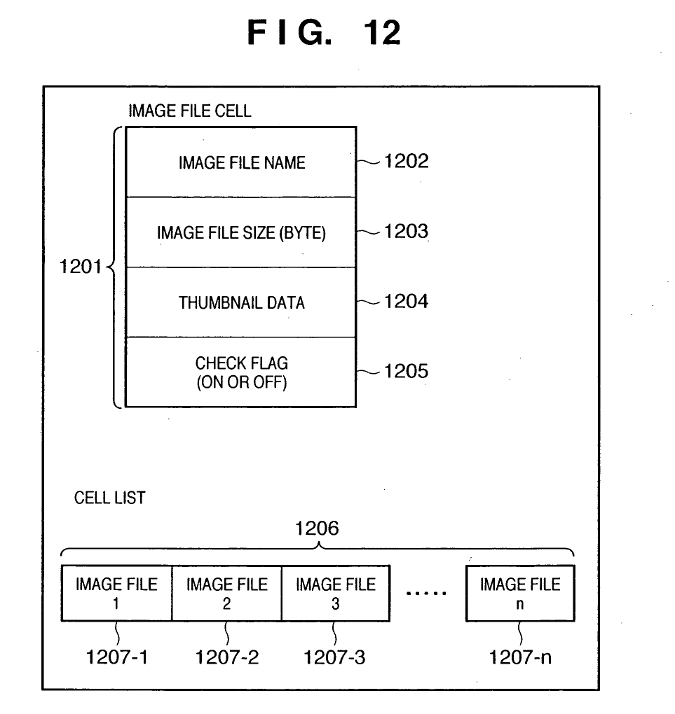

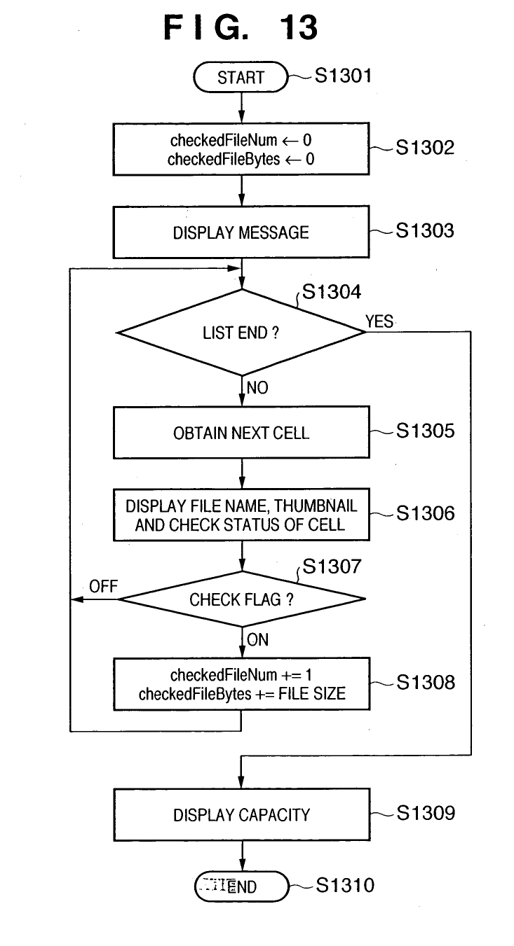

Next, the data structure and the operation of the upload program will be described with reference to FIGS. 12 and 13.

FIG. 12 illustrates an example of the data structure in the RAM 202 allocated by the upload program 602 for management of added image file(s) upon addition of image file (sequence 613) to the canvas 1102 of the upload screen image.

Numeral 1201 denotes a data structure corresponding to one image file. The data structure will be referred to as a cell. Numeral 1202 denotes an image file name. The image file name is notified from the OS when an image file is dropped to the canvas 1102. Numeral 1203 denotes an image file size which is obtained by the upload program 602 from the OS by inquiry when an image file has been dropped to the canvas 1102. The unit of the image file size is byte. Numeral 1204 denotes thumbnail data, which is generated as a small image representation of the image file by reading the content of image file by the upload program 602 when the image file is dropped to the canvas 1102. The thumbnail data 1204 is stored as binary data into the RAM 202, however, since it cannot be illustrated, the content of thumbnail data is indicated in the figure. Numeral 1205 denotes a check flag used for management as to whether or not an added image file is actually uploaded. The check flag 1205 has any one of “on” (to be uploaded) and “off” (not to be uploaded) statuses. When an image file is dropped, the flag status is “on”, however, the status can be changed to “off” by the user's operation thereafter.

Numeral 1206 denotes a list structure connecting plural cells 1201. As shown in the figure, cells 1207-1 to 1207-n are allocated in correspondence with image files 1 to n, and the cells are stored in sequence in the list, thereby the plural cells and the order of the cells are managed.

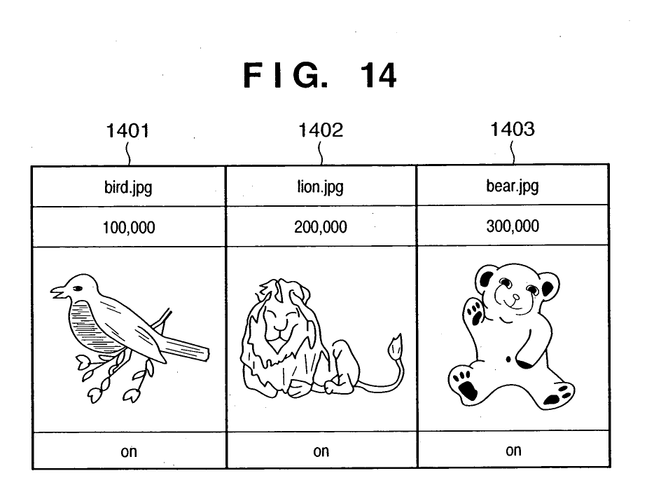

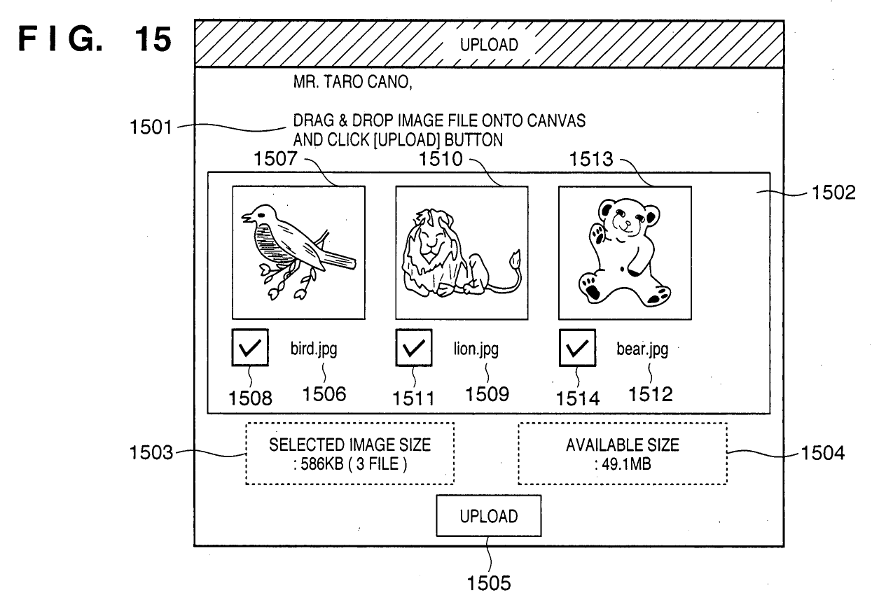

FIG. 13 is a flowchart showing the operation to display the upload screen image by the upload program 602 on the display 205 (sequence 614). Assuming that the user has added image files in the upload screen image and as a result the cell list is as shown in FIG. 14, the upload screen image is displayed as shown in FIG. 15. The display operation will be described with reference to the flowchart of FIG. 13.

The operation is started from step S1301. At step S1302, initialization processing is performed. “checkedFileNum” is the number of image files to be uploaded, i.e., the number of cells having “on” check flag 1205 in the cell list 1206. “checkedFileBytes” is the total size of the image files to be uploaded, i.e., the total value of the sizes of the image files of the cells having “on” check flag 1205 in the cell list 1206. At step S1302, both “checkedFileNum” and “checkedFileBytes” are initialized to “0”.

At step S1303, the message portion 1501 is displayed. The name “Taro Cano” used as the returned value at sequence 611 is used as a part of the message.

At step S1304, determination is made as to whether or not all the cell list has been displayed. In this example, as nothing has been displayed, the process proceeds to step S1305.

At step S1305, determination of cell to be displayed next is performed. In this example, the head cell 1401 of the list is selected.

At step S1306, the file name, the thumbnail and the check status of the cell are displayed. The file name 1202, selected at step S1304, the thumbnail 1204 and the status of the check flag 1205 are displayed on the canvas 1502. In this example, as the cell 1401 is selected, a file name “bird.jpg” is displayed in a field 1506, and a thumbnail (See 1401) is displayed in a field 1507. As to the check flag, a status “✓” (check mark) indicates “on”, while no checked status indicates “off”. In this example, as the check flag of the cell 1401 is “on”, the checked status is displayed in a field 1508.

At step S1307, determination is made as to whether the check flag 1205 of the cell is “on” or “off”. In this example, as the status is “on” (1401), the process proceeds to step S1308.

At step S1308, variable update processing is performed. First, “1” is added to the number of image files to be uploaded (checkedFileNum). Then, the image file size (100,000 as indicated in 1401) is added to the total image file size of the images to be uploaded (checkedFileBytes). As a result, “checkedFileNum” becomes “1”, and “checkedFileBytes” becomes “100,000”. Then the process returns to step S1304.

Next, steps S1304 to S1308 are applied to the cell 1402, then as a result, display in fields 1509 to 1511 is obtained, and “checkedFileNum” becomes “2” and “checkedFileBytes” becomes “300,000”. Thereafter, the process returns to step S1304.

Next, steps S1304 to S1308 are applied to the cell 1403, then as a result, display in fields 1512 to 1514 is obtained, and “checkedFileNum” becomes “3” and “checkedFileBytes” becomes “600,000”. Thereafter, the process returns to step S1304.

As all the cell list shown in FIG. 14 is displayed, the process proceeds through the determination at step S1304 to step S1309.

At step S1309, the capacity is displayed. First, as denoted by 1503, the total size of and the number of the image files to be uploaded are displayed by utilizing “checkedFileBytes” and “checkedFileNum”. In this example, “checkedFileBytes” is “600,000 bytes”=“585.9375 kilobytes”≅“586 kilobytes”, “586 KB” is displayed. Further, as “checkedFileNum” is “3”, “3 files” is displayed. Next, as denoted by 1504, the available album size is displayed. As the available album size returned as a returned value at sequence 611 is used, “49.1 MB” as in the case of 1401 is displayed. In this manner, upon selection of image file(s) to be uploaded, as the total file capacity of currently-selected image file(s) and the available album size obtained at sequence 611 are displayed, the user can easily determine whether or not the size of the selected image(s) exceeds the remaining capacity of the storage area as a transfer destination if the selected image(s) are transferred.

Then, the process ends at step S1310.

<Operation Upon Image File Selection>

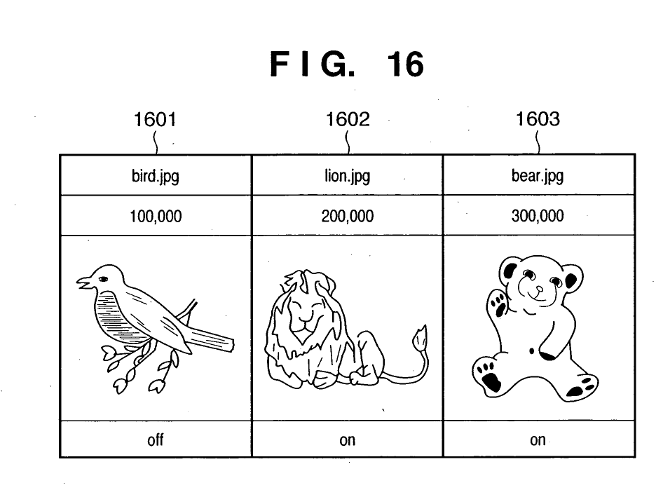

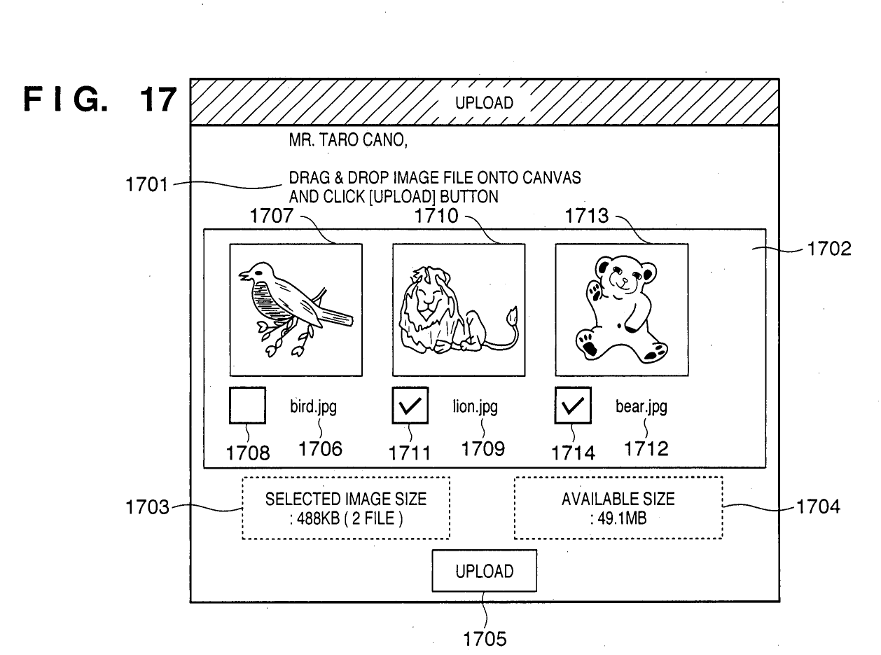

Next, the operation upon image file selection will be described with reference to FIGS. 16 to 17.

When the screen image as shown in FIG. 15 has been obtained by addition of image file(s) to the screen image shown in FIG. 11, the user 601 can set the image check flag of added image file to “off” or “on” (sequence 613). The operation is made by operating the check flag display of added image file with the keyboard 206 and/or the pointing device 207 of the client 101. For example, if the check flag display in the field 1508 in FIG. 15 is clicked by using the pointing device 207, as the OS notifies the operation to the album display program 603, the album display program 603 changes the check flag of the corresponding cell to “off”. As a result, in the cell list, the check flag of the head cell 1601 becomes “off”.

When the cell list has been changed, the upload program 602 re-displays the upload screen image (sequence 614). When the cell list shown in FIG. 16 is re-displayed in accordance with the flowchart of FIG. 13, a screen image as shown in FIG. 17 is obtained. The difference, between FIGS. 15 and 17 is the difference of check flag between the cell 1401 and the cell 1601. The check flag display in the field 1507 is different from that in a field 1708, and the selected image size & number of files display in the field 1503 is different from that in a field 1703. In the cell list shown in FIG. 16, as the number of “on” check flag cells is 2 (1602, 1603), the total number of image files to be uploaded (1703) is “2”, and as the total size of the image files is “500,000 bytes”=“488.281 kilobytes”≅“488 kilobytes” holds, “488 KB” is obtained.

Note that at step S1309, it may be arranged such that in the screen image as shown in FIG. 15, the available album size when the selected image file(s) are uploaded is also displayed. More particularly, the difference between the value of “checkedFileBytes” and the returned value at sequence 611 is calculated, and the obtained difference is displayed as an assumed available album size. As the user can easily obtain the available album size after upload of the currently-selected image(s), the user can easily additionally select further image(s) to be uploaded or select image(s) to be deleted.

<Operation of Upload CGI>

The operation of the upload CGI will be described with reference to FIGS. 18 and 19.

FIG. 18 is a flowchart showing the operation of the upload CGI 606 (sequence 616). FIG. 19 is an example of the album information database after upload by the upload CGI 606.

In this example, it is assumed that the user 601 operates an upload button 1705 when the upload program 603 having the internal status shown in FIG. 16 displays the upload screen image shown in FIG. 17. The upload program calls the upload CGI 606 for respective cells with “on” check flag 1205. In this example, the upload CGI 606 is called regarding the cells 1602 and 1603. Hereinbelow, the calling regarding the cell 1602 will be described.

At step S1801, processing by the upload CGI is started. As the user ID and the password inputted by the user 601 at sequence 610 are forwarded as HTTP request parameters from the upload program 602, the parameters are substituted into variables “userId” and “password”. In this example, the user ID “ID1234” and the password. “PAS5678” are forwarded as shown in FIG. 8. Further, the file name and image file data of the cell are forwarded as HTTP request parameters from the upload program 602; and the parameters are substituted into variables “fileName” and “fileData”. The file name is that held in 1202. As the image file data is not held in the cell data structure 1201, the upload program 602 reads data of the image file 303 from the external storage unit 204 with the file name 1202 as a key, and forwards the file data as an argument to the upload CGI 606. In this example, the file name in 1602 (lion.jpg) and image file data are forwarded.

Next, at step S1802, a record with “userId” corresponding with the user ID 402 is retrieved from the user information database 401. As shown in FIG. 4, as the user ID 402 is a PK, there is only one record with “userId” corresponding with the user ID 402.

At steps S1803 and S1804, authentication processing similar to that at steps S903 and S904 is performed. Since the record having the same user ID and password has been already checked at sequence 611, the result of checking processing here always becomes successful. The purpose of the processing at steps S1803 and S1804 is preparation for calling of the upload CGI 606 from other program than the upload program 602.

At step S1805, the image file size is calculated from the image file data “fileData” forwarded as an argument, and a thumbnail is generated. In this example, as shown in the cell 1602, an image file “200,000” is obtained. Further, a thumbnail approximately the same as that denoted by 1602 is generated. Since the thumbnail in FIG. 16 is generated by the upload program 602 on the client 101 while the thumbnail generated in this example is generated by the upload CGI 606 on the server 102, they are not always the same. However, as the thumbnails are generated from the same image file data, thumbnails approximately the same on screen are generated.

At step S1806, a new record is added to the album information database 501. As the user ID 502, “userId” is used, and as the image file name 503, “fileName” is used. As the image file size 504, the image file size calculated at step S1805 is used. As the thumbnail data 505, the thumbnail generated at step S1805 is used. As the image file data 506, “fileData” is used. The result of addition is as denoted by 1904 in FIG. 19.

At steps S1807 and S1808, processing to indicate success and failure are performed.

In this example, the calling regarding the cell 1602 has been described, however, similar processing is performed regarding the cell 1603. The result of addition of new record to the album information database 501 for the cell 1603 is as denoted by 1905 in FIG. 19.

As described above, as a result of addition of image files indicated in the cells 1602 and 1603 to the album information database shown in FIG. 5 in accordance with the flowchart of FIG. 18, the album information database as shown in FIG. 19 is obtained.

<Operation of Album Display CGI>

Next, the operation of the album display. CGI will be described with reference to FIGS. 20 and 21.

FIG. 20 is a flowchart showing the operation of the album display CGI 607 (sequence 618).

The processing by the album display CGI 607 starts from step S2001. As the user ID and the password inputted by the user 601 at sequence 610 are forwarded as arguments upon starting of the album display program 603, the album display program 603 forwards the arguments as HTTP request parameters to the album display CGI 607. In this example, the user ID “ID1234” and the password “PAS5678” are forwarded as shown in FIG. 8.

At step S2002, a record with “userId” corresponding with the user ID 402 is retrieved from the user information database 401. As shown in FIG. 4, as the user ID 402 is a PK, there is only one record with “userId” corresponding with the user ID 402.

At steps S2003 and S2004, authentication processing similar to that at steps S903 and S904 is performed. Since the record having the same user ID and password has been already checked at sequence 611, the result of checking processing here always becomes successful. The purpose of the processing at steps S2003 and S2004 is preparation for calling of the album display CGI 607 from other program than the album display program 603.

At step S2005, records with “userId” corresponding with the user ID 502 are retrieved from the album information database 501. In this example, 5 records 1901 to 1905 as shown in FIG. 19 are retrieved.

At step S2006, regarding all the records found at step S2005, the image file name 503 and the thumbnail data 505 are returned in the form of HTTP response as returned values. Further, the name 404 in the record found at step S2002 is also returned. In this example, the image file names “car.jpg”, “plane.jpg”, “ship.jpg”, “lion.jpg”, “bear.jpg” and the illustrated thumbnails, and the name 404 “Taro Cano” are returned.

FIG. 21 is an example of an album display screen image displayed by the album display program 603 on the display 205 at sequence 619. A message indication 2101 is made by using the name returned from the album display CGI, and an image indication 2102 is made by using the file names and thumbnail data returned from the album display CGI.

As described above, according to the present embodiment, as an available album size is obtained before an upload screen image is displayed, the user can be previously informed of the remaining capacity of the storage area for the user on the server when the user is selecting image(s) to be uploaded.

Further, upon selection of image file(s) to be uploaded, as the total capacity of currently-selected images and the previously-obtained available album size are displayed, the user can easily determine whether or not the capacity of the selected image(s) exceeds the remaining capacity of the storage area is the selected image(s) are transferred.

<Other Embodiments>

In the above-described embodiment, only image files are handled, however, moving image and audio files can be similarly handled.

Further, in FIG. 1, numeral 103 denotes the Internet, however, any other network than the Internet may be utilized as long as it is a medium enabling data transmission/reception via a computer network interface. Further, any other protocol than HTTP protocol may be used as long as software on both client and server can utilize the protocol.

Further, in FIG. 2, the programs are stored in the RAM 202, however, the storage is not limited to this arrangement. For example, as other embodiments, the programs may be read from the external storage unit 204, otherwise, received via the network interface 2003 and executed. Further, although not shown in FIG. 2, the programs may be read from an internal read-only storage such as a ROM and executed. Further, an input device such as voice input device may be used in addition to or in place of the keyboard 206 and the pointing device 207. Further, all these constituent elements are not necessary prepared. For example, the display 205 may be omitted on the server 102, and/or the keyboard 206 and the pointing device 207 may be used with other computers as common devices.

Further, in FIG. 3, the upload program 302 and the album display program 304 on the client are different programs, but they may be realized as different functions of one program. Further, in FIG. 3, these programs are independent programs, however, they may be realized as plug-in programs such as ActiveX which operates on a Web browser. Further, they may be realized as script language such as JavaScript which operates on the Web browser.

The user information database and the album information database may be constructed to store other various information than those as shown in FIGS. 4 and 5. For example, the user information may include information on address and/or telephone number, and the album information may include information on album name and/or date of generation. Further, in the above embodiment, the thumbnail data and image file data are held in the database as binary data, however, as another embodiment, it may be arranged such that binary data is held as a file in a file system or the like, and information indicating the position of the binary data (URL, path name in the file system or the like) is held in the database.

Further, in the above embodiment, one album exists in correspondence with one user, however, it may be arranged such that plural albums corresponding to one user are discriminated by album name or the like. Further, a folder to hold plural albums may be provided. Further, if the folder includes other folder(s), the album has a hierarchical structure.

Further, in FIG. 6, the image files are uploaded by the upload CGI one by one as shown at sequence 616, however, the interface and the operation of the CGI may be changed such that plural image files are uploaded at once by using a protocol such as RFC1867 or RFC2854. Further, the interface and operation of the CGI may be changed such that an image file having a large file size is divided and uploaded by plural times of CGI callings.

Further, the authentication information (user ID and password) is forwarded in every CGI calling, however, it is generally arranged such that sessions are managed on the server side, and upon each CGI calling, only information discriminating the session (session ID) is forwarded.

In FIG. 6, the available album capacity is obtained only at sequence 611, however, it may be arranged such that the remaining capacity is obtained on the client side at other timings or periodically by communication with the server and the display of upload screen image is updated.

Further, in the upload screen image shown in FIGS. 11, 15 and 17, only the function of changing check status exists in addition to the function of adding image file(s), however, the present invention is not limited to this arrangement. For example, other editing functions such as image file deletion, change of file name, and exchange/sort of image file(s) may be added.

Further, in the flowchart of FIG. 13, all the upload screen image is re-drawn upon change of image file check status, however, only a changed part may be re-displayed.

Further, at step S1805 in FIG. 18, the image file size is calculated and the thumbnail is generated on the server side, however, as these information are also held on the client side, they may be sent from the client side as a part of the upload CGI arguments.

Note that the present invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2003-394264 filed on Nov. 25, 2003 and Japanese Patent Application No. 2004-314724 filed on Oct. 28, 2004, the entire contents of which are incorporated by references herein.

1. An information processing apparatus, connected via a network to a server to provide a predetermined amount of data storage area, configured to perform file transfer to the data storage area, comprising:
an input device to input an instruction from a user;
a display device to display an image;
acquisition means for acquiring information on an available capacity of the data storage area from the server;
display control means for, upon receipt of the information acquired by said acquisition means, causing said display device to display a graphical user interface (GUI) for the user to select a file to be transferred to the data storage area;
selection means for selecting a file to be transferred to the data storage area based on a drag-and-drop designation with said input device to the displayed GUI; and
calculation means for, in response to the drag-and-drop designation with said input device to the GUI, calculating a difference value between a total size of the files currently selected by said selection means and the available capacity of the data storage area acquired by said acquisition means,
wherein the GUI includes a display area to dynamically display the difference value calculated by said calculation means in response to the drag-and-drop designation with said input device.

2. The information processing apparatus according to claim 1, wherein the GUI further includes a designation button to send a file transfer instruction for the file selected by said selection means.

3. The information processing apparatus according to claim 1, further comprising generation means for generating a small image representation of the file selected by said selection means,
wherein said GUI further includes an area to display the small image representation generated by said generation means.

4. The information processing apparatus according to claim 1, further comprising setting means for setting with said input device as to whether or not file transfer to the data storage area is performed, regarding respective files selected by said selection means,
wherein said calculation means calculates the difference value between the total size of the files set by said setting means as files to be transferred to the data storage area and the available capacity of the data storage area acquired by said acquisition means, in response to setting by said setting means with said input device,
and wherein the GUI includes a display area to dynamically display the difference value calculated by said calculation means in response to the setting by said setting means with said input device.

5. A control method for an information processing apparatus, connected via a network to a server to provide a predetermined amount of data storage area, configured to perform file transfer to the data storage area, comprising:
an acquisition step of acquiring information on an available capacity of the data storage area from the server;
a display control step of, upon executing said acquisition step, causing a display device to display a graphical user interface (GUI) for the user to select a file to be transferred to the data storage area;
a selection step of selecting a file to be transferred to the data storage area based on a drag-and-drop designation with an input device to the displayed GUI; and
a calculation step of, in response to the drag-and-drop designation with the input device to the GUI, calculating a difference value between a total size of the files currently selected by said selection step and the available capacity of the data storage area acquired at said acquisition step,
wherein the GUI includes a display area to dynamically display the difference value calculated at said calculation step in response to the drag-and-drop designation with the input device.

6. A program executed by an information processing apparatus, connected via a network to a server to provide a predetermined amount of data storage area, configured to perform file transfer to the data storage area, comprising:
code of acquisition step of acquiring information on an available capacity of the data storage area from the server;
code of display control step of, upon executing said acquisition step, causing a display device to display a graphical user interface (GUI) for the user to select a file to be transferred to the data storage area;
code of selection step of selecting a file to be transferred to the data storage area based on a drag-and-drop designation with an input device to the displayed GUI; and
code of calculation step of, in response to the drag-and-drop designation with the input device to the GUI, calculating a difference value between a total size of files currently selected by said selection step and the available capacity of the data storage area acquired at said acquisition step,
wherein the GUI includes a display area to dynamically display the difference value calculated at the calculation step in response to the drag-and-drop designation with the input device.

7. A computer-readable storage medium storing the program according to claim 6.

8. A network system including a server to provide a predetermined amount of data storage area and a client configured to perform file transfer to said server,
wherein said server comprising:
available amount examination means for examining an available capacity of the data storage area in response to an instruction from said client,
and wherein said client comprising:
an input device to input an instruction from a user;
a display device to display an image;
acquisition means for acquiring information on an available capacity of the data storage area by issuing a request to said server;
display control means for, upon receipt of the information acquired by said acquisition means, causing said display device to display a graphical user interface (GUI) for the user to select a file to be transferred to said data storage area;
selection means for selecting a file to be transferred to the data storage area based on a drag-and-drop designation with said input device to the displayed GUI; and
calculation means for, in response to the drag-and-drop designation with said input device to the GUI, calculating a difference value between a total size of files currently selected by said selection means and the available capacity of said data storage area acquired by said acquisition means,
wherein said GUI includes a display area to dynamically display the difference value calculated by said calculation means in response to the drag-and-drop designation with said input device.
